(19) United States
(12) Patent Application Publication
(10) Pub. No.: US 2020/0354620 A1
(43) Pub. Date: Nov. 12, 2020

(54) METHODS AND COMPOSITIONS FOR PLUGGING A WELLBORE OR SUBTERRANEAN FORMATION

(71) Applicant: NewWell Tech, LLC, Sugar Land, TX (US)

(72) Inventors: Zhijie HUANG, Sugar Land, TX (US); Qiang WANG, Spring, TX (US)

(73) Assignee: NewWell Tech, LLC, Sugar Land, TX (US)

(21) Appl. No.: 16/868,313

(22) Filed: May 6, 2020

Related U.S. Application Data
(60) Provisional application No. 62/846,507, filed on May 10, 2019.

(51) Int. Cl. C09K 8/42; E21B 33/138

(52) U.S. Cl. CPC C09K 8/426; E21B 33/138

(57) ABSTRACT

The present disclosure relates to methods of plugging a wellbore or formation in a subterranean environment, and systems for the practice thereof. Benefits of the methods disclosed herein can include providing the use of versatile aqueous polymer solutions that can penetrate into wellbores and deep into subterranean formations, while forming strong sealant materials effective at formation temperatures and pressures, and at various distances from a wellbore in a formation.

### CROSS-REFERENCE TO RELATED APPLICATIONS

This application claims priority to U.S. Provisional Application No. 62/846,507, filed on May 10, 2019, the entirety of which is incorporated by reference.

### TECHNICAL FIELD

The present disclosure relates to methods of plugging a wellbore or formation in a subterranean environment, and systems for the practice thereof. Benefits of the methods disclosed herein can include the use of versatile aqueous polymer solutions that can penetrate into a wellbore and into subterranean formations at various distances, while forming strong sealant materials effective at formation temperatures and pressures.

### BACKGROUND

Controlling the flow of fluids between a wellbore and formations in subterranean environments is a central concern in the oil and gas industry. Various chemical and mechanical plugging processes exist to seal off or isolate areas of the wellbore and surrounding formations, in order to facilitate fluid loss, conformance, or re-fracturing operations. Among such processes is the use of polymers that can be chemically activated and that can be pumped into a wellbore or subterranean environment, where the polymers can set up in a wellbore or a formation to form a gel or a solid sealant that plugs the wellbore or formation and reduces its permeability. The use of polymers as plugging agents can be used in conjunction with the fracturing and re-fracturing of wells, as well as in combination with various other chemical and mechanical techniques for formation fluid control.

### SUMMARY

Embodiments herein are directed to methods of plugging a wellbore or formation in a subterranean environment, and related systems and compositions for the practice thereof. In an embodiment, a method of plugging a wellbore or formation in a subterranean environment is disclosed. In certain embodiments, such a method includes providing a polymer. In certain embodiments, said polymer includes a polyacrylamide polymer. In certain embodiments, the polyacrylamide polymer has a weight average molecular weight of from about 100 Daltons to about 100,000 Daltons. In certain embodiments, the polyacrylamide polymer has a weight average molecular weight of from about 200 Daltons to about 50,000 Daltons. Embodiments of the methods herein provide an aqueous crosslinking solution including a crosslinker. In certain embodiments, such a crosslinker has a molecular weight of from about 60 Daltons to about 100,000 Daltons. In certain embodiments, methods herein include combining the polymer and the aqueous crosslinking solution before injection into the wellbore. In certain embodiments, methods herein include combining the polymer and the aqueous crosslinking solution during injection into the wellbore. In certain embodiments, methods herein include forming a crosslinked plug in a wellbore or formation in a subterranean environment, wherein the subterranean environment is located at a distance from the wellbore. In an aspect, the crosslinked plug can withstand a pressure differential of from about 2000 psi to about 5000 psi.

In certain embodiments disclosed herein, the polyacrylamide polymer is from about 90 percent to 100 percent linear. In certain embodiments, the polyacrylamide polymer is contained in an aqueous polymer solution at a concentration of from about 40 percent to about 99 percent by weight based on a total weight of the aqueous polymer solution. In certain embodiments, the crosslinker has a concentration of about 20 percent to about 99 percent weight based on a total weight of the aqueous crosslinker solution.

Embodiments of the methods disclosed herein include combining an aqueous polymer solution and an aqueous crosslinking solution to form a combined solution. In certain embodiments, the combined solution has a concentration of about 30 percent to about 80 percent by weight polyacrylamide polymer and from about 10 percent to about 40 percent by weight crosslinker based on a total weight of the combined solution. In certain embodiments, the combined solution has a weight ratio of polyacrylamide to crosslinker of about 5:1 to about 4:1. In certain embodiments, the combined solution contains one crosslinker molecule per 5 to 10 monomer units of the polyacrylamide polymer based on an average number of units in the polyacrylamide polymer. In certain embodiments, the combined solution has a molar ratio of polyacrylamide to crosslinker of from about 4:1 to about 6:1.

Embodiments of methods herein provide combining an aqueous polymer solution and an aqueous crosslinking solution at a ratio of from about 3:1 to about 6:1 by volume to form a combined solution. In certain embodiments, such a combined solution is formed before pumping the combined solution into the wellbore. Certain embodiments provide for injecting an aqueous polymer solution and an aqueous crosslinking solution at a ratio of from about 6:1 to about 10:1 by volume, simultaneously or in any sequence, and forming a combined solution in the wellbore or the subterranean environment.

In certain embodiments, the crosslinker is selected from diamine, triamine, tetraamine, pentaamine, hexamethylenetetramine, and combinations thereof. Certain embodiments of methods herein provide that the crosslinker includes hexamethylenetetramine. Certain embodiments include degrading a plug from a subterranean environment after a duration by including a degradative amount of hexamethylenetetramine in an aqueous crosslinking solution.

In certain embodiments, the method of plugging a wellbore or formation in a subterranean environment includes providing one or more diverter materials; and injecting the one or more diverter materials into the wellbore before, during, or after injection of the polymer solution and the aqueous crosslinking solution into the wellbore.

In certain embodiments, at least one of an aqueous polymer solution and an aqueous crosslinking solution includes a crosslinking accelerator. In certain embodiments, the crosslinking accelerator includes a base, a Lewis base, or a combination thereof. Additional embodiments further provide adding a retarding agent. In certain embodiments, the retarding agent includes an acid, a Lewis acid, or a combination thereof In certain embodiments, a retarding agent is added to at least one of the aqueous polymer solution and the aqueous crosslinking solution.

Methods of plugging a wellbore are disclosed herein providing isolating an area of the subterranean environment within the wellbore or at a distance from the wellbore. In certain such embodiments, embodied methods include providing an aqueous polymer solution. In certain embodiments, the aqueous polymer solution includes a polyacrylamide polymer. In certain embodiments, the polyacrylamide polymer has a weight average molecular weight of from about 100 Daltons to about 100,000 Daltons. In certain embodiments, the polyacrylamide polymer has a concentration of from about 40 percent to about 99 percent by weight based on a total weight of the aqueous polymer solution. In certain embodiments, the polyacrylamide polymer is from about 90 percent to 100 percent linear. Embodiments of methods herein include providing an aqueous crosslinking solution including a crosslinker. In certain embodiments, the crosslinker is at a concentration of about 20 percent to about 99 percent by weight based on a total weight of the aqueous crosslinker solution. Embodiments of methods herein include pumping the aqueous polymer solution and the aqueous crosslinker solution into a wellbore. Certain embodiments include forming a combined solution by mixing an aqueous polymer solution and an aqueous crosslinker solution and pumping the combined solution into a wellbore. Certain embodiments include forming a crosslinked plug in a subterranean environment within a wellbore or at a distance from a wellbore. In certain embodiments, crosslinked plugs are formed in a subterranean environment at a plurality of distances from a wellbore. In an aspect, the subterranean environment is located in a previously fractured region of a wellbore.

Additional embodiments herein disclose a kit or device for plugging a wellbore. Certain embodiments of such a kit or device provide a polymer vessel and a crosslinker vessel. In certain embodiments, the polymer vessel contains an aqueous polymer solution. In certain embodiments, the aqueous polymer solution includes a polyacrylamide polymer. In certain embodiments, the polyacrylamide polymer has a weight average molecular weight of from about 100 Daltons to about 100,000 Daltons. In certain embodiments, the polyacrylamide polymer has a concentration of from about 40 percent to about 99 percent by weight based on a total weight of the aqueous polymer solution. In certain embodiments, the polyacrylamide polymer is from about 90 percent to 100 percent linear. Embodiments herein disclose a crosslinker vessel containing an aqueous crosslinking solution including a crosslinker. In certain embodiments, the crosslinker is at a concentration of about 20 percent to about 99 percent by weight based on a total weight of the aqueous crosslinker solution. Certain embodiments herein provide that the polymer vessel and the crosslinker vessel of the kit or device are separated.

### BRIEF DESCRIPTION OF THE DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown. Unless otherwise noted, the drawings are not to scale.

FIG. 1 shows an illustration of an embodiment of methods herein.

FIG. 2 shows an illustration of an embodiment of methods herein.

FIG. 3 shows an illustration of an embodiment of methods herein.

FIG. 4 shows an illustration of an embodiment of methods herein.

FIG. 5 shows a graph of temperature and pressure testing results in a lab equipment according to embodied methods.

FIG. 6 is a graph showing a subsection of the results in FIG. 5.

FIG. 7 is a graph showing pressure testing results in a wellbore according to embodied methods.

FIG. 8 is a graph showing retarder effects on crosslinking reactions according to embodiments herein.

FIG. 9 is a graph showing retarder effects on crosslinking reactions according to embodiments herein.

FIG. 10 is a graph showing the results of a degradation experiment according to embodiments herein.

FIG. 11 is a graph showing a subsection of the results in FIG. 10.

FIG. 12 is a graph showing a subsection of the results in FIG. 10.

FIG. 13 is a graph showing accelerator effects on crosslinking reactions according to embodiments herein.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of an aqueous polymer solution and an aqueous crosslinking solution” means an aqueous polymer solution, an aqueous crosslinking solution, or any combination thereof.

Unless otherwise noted, the term “about” refers to ±10% of the non-percentage number that is described, rounded to the nearest whole integer. For example, about 100 mm, would include 90 to 110 mm. Unless otherwise noted, the term “about” refers to ±5% of a percentage number. For example, about 20% would include 15 to 25%. When the term “about” is discussed in terms of a range, then the term refers to the appropriate amount less than the lower limit and more than the upper limit. For example, from about 100 to about 200 mm would include from 90 to 220 mm.

Unless otherwise noted, properties (height, width, length, ratio etc.) as described herein are understood to be averaged measurements.

In many cases, it is desired to seal off perforations or pathways of a wellbore or subterranean formation. For example, some wells begin to produce water or unwanted gas from a high percentage of the wellbore structure, which can ultimately hinder the further production of oil or gas. It can be desired to seal off the perforations or pathways that produce water, in order to improve hydrocarbon production. During drilling, a wellbore may encounter mud loss to the formation. It can be desired to seal off the fracture or pathway that causes the mud loss, so that the drilling operation can continue. In many cases, hydraulic fracture treatments fail to recover a large quantity of remaining hydrocarbon resources. To effectively extract these hydrocarbons, the reservoir rocks that were not fractured during the first hydraulic fracture treatment may need to be re-fractured. To maximize the benefit of refracturing, it can be desired to seal off the old fractures so that new fractures can be created during the re-fracturing process. Due to low matrix permeability, several years of production can cause a significant reservoir pressure drop around old fractures, where the pore pressure within this zone can be four to five thousand psi lower than the areas not fractured, causing the dilation of old fractures instead of creation of new fractures during refracturing. The complexity of fractures near the wellbore area also creates difficulty in isolating the old fractures in order to create new fractures. Current re-fracturing methods focus on blocking the entrance point of the fracture and do not block any old path in the near-wellbore region. This makes it very likely that fracturing fluid will flow into old fractures through one of the existing pathways of the complex near wellbore networks, making it difficult to create new fractures.

Current plugging processes present challenges to the sealing and isolation of wellbores and formations in subterranean environments in connection with hydraulic fracturing operations. Cementing methods are used to stabilize and isolate the wellbore from the surrounding formation, and to re-isolate the wellbore in re-fracturing operations with the use of tubing strings. The use of cement results in very shallow penetration into the near wellbore area of the formation, however. Fractures near a wellbore area can be very complex, and normally there are multiple fractures leading to the main fracture. With shallow penetration, the chance to seal off all pathways leading to the main fracture is low. Also, cement shrinks when set, thus the seal may leak. Field experience shows that using cement to squeeze off perforations is very unreliable, and that it often fails to form an effective seal.

Diverter techniques make use of degradable particles of various sizes to isolate previously fractured or perforated regions of a wellbore. These particles degrade after the treatment to allow production. However, the use of such diverters can be very unreliable. It can be difficult to tell how much diverter material is needed, because formations are not homogeneous, and because it can be difficult to know how many perforations are open. If too little diverter material is used, the open perforations will not be blocked sufficiently to allow fracturing fluid to move preferentially to new perforations. Diverter particles may also not penetrate deep into the existing fractures. Thus, seals formed by diverters can fail during subsequent treatment, allowing fluid to flow undesirably into previous fractures.

An expandable liner method can also be used to seal off a wellbore. In this method, a section of a liner is run to the depth where the sealing is desired. A downhole tool expands the liner, thus sealing off the old wellbore. However this method is expensive and takes lots of time. Besides, there is high risk that the tool can get stuck when it expands the liner.

Wellbores can also be sealed using a casing-in-casing method. In this method, a smaller casing is run into an existing casing, then the gap between the two casings is sealed with cement. This method is also expensive and time consuming. It is also very challenging to have a good cementing sheath between the two casings. Another disadvantage is that in order to reconnect the wellbore to the formation, the perforation has to penetrate two casings and two cementing sheaths.

Low strength gels can also be used to shut off water production. Use of such a low strength gel may be enough to plug off pores on a micrometer scale, but it won't create a secure seal for an inch-wide fracture.

Embodiments of the present disclosure can provide methods to reliably and effectively plug or seal off a wellbore or a formation in a subterranean environment. Embodiments of the disclosed methods herein can provide the use of a sealant material with a low viscosity, pumpable liquid formulation. A benefit of such a liquid formulation, having a low initial viscosity before crosslinking occurs, can include the ability of the sealant material to penetrate not only near the wellbore area or perforation holes, but deep into existing fractures, providing a further advantage to its sealing capability at various distances from a wellbore. Various embodiments herein provide the use of a polymer that can undergo a crosslinking reaction to form a strong gel or solid material after the liquid formulation enters fractures and perforations, effectively plugging or sealing off the openings. Such embodiments can provide an advantage of a strong, durable plug or seal that can withstand the extreme temperature and pressure conditions encountered in subterranean environments and/or re-fracturing procedures. Other embodiments can provide advantageous methods to accelerate or retard the crosslinking reaction, or methods to degrade the plug after a duration of time. In an embodiment, the disclosed methods can be applied to allow a wellbore to be fractured and re-fractured repeatedly. For example, the disclosed methods can be useful to plug or to seal off all the existing fractures and perforations in an old well, so that the wellbore is ready to be treated again.

### Embodiments of Wellbore and Formation Plugging Methods

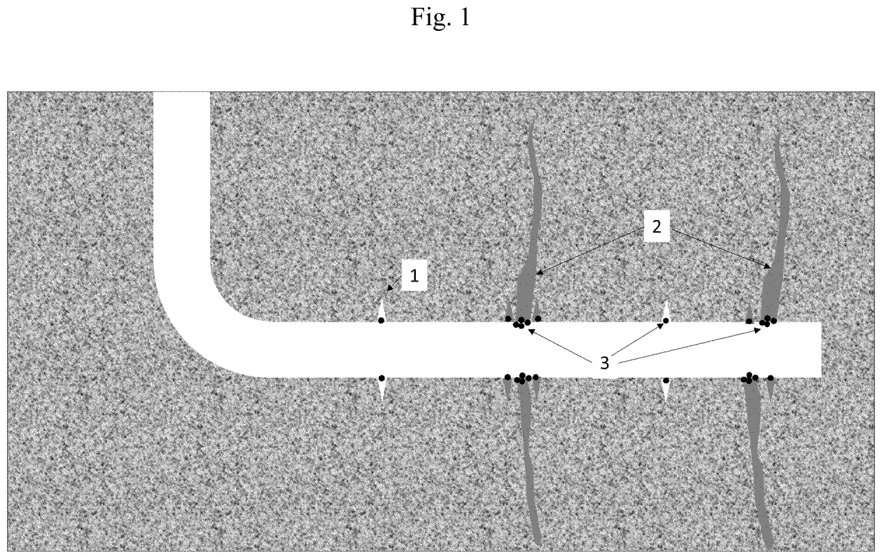

An embodiment of a method of plugging a wellbore or formation in a subterranean environment as disclosed herein is shown in FIG. 1. A combined solution of aqueous polymer solution and aqueous cross linker solution (“sealant material”), and in some embodiments followed by diverting agents, can be bullheaded into a wellbore that has been fractured. In various embodiments, diverting agents may include solid particles, plastic particles, perforation balls, and similar diverting materials. Once the sealant material is set, the wellbore is cleaned. 1: perforations that were not fractured in a previous hydraulic fracturing treatment; 2: hydraulic fractures that were created in a previous treatment are sealed off by the sealant in this method; 3: diversion particles.

In some embodiments, the method includes injecting or pumping one or more diverting agents into a wellbore before injecting a combined solution of aqueous polymer and aqueous cross linker solution (“sealant material”) into the wellbore. In certain embodiments, the injecting of the sealant material can be done as part of a break down-squeeze sequence. There may be some perforation holes that where shot, but not fractured, in a previous fracturing operation. When pumping a sealant material into the wellbore, the injection pressure can be controlled to be above the formation breakdown pressure; this can break down the formation behind such perforation holes, whether or not such holes were fractured or not fractured in the previous fracture treatment. In such a break down-squeeze sequence, the sealant material can be pumped into the wellbore above the formation break down pressure, all the way up to a maximum allowed surface pressure. The pumping can be stopped to allow the sealant material to be squeezed into the formation, and allow the pressure to drop to below the break down pressure. This can be repeated many times. In certain embodiments, the one or more diverting agents can include plastic particles having an average diameter of from about 2 mm to about 4 mm. In certain embodiments, the average diameter of the particles can be varied to be suitable for the desired diversion effect. In such embodiments, the plastic particles can partially block perforations that would otherwise tend to take up a greater proportion of fluid injected into the wellbore. When the sealant material is injected into the wellbore, the sealant material can then effectively seal all or most of the perforations, rather than relatively few of the perforations. In some embodiments, one or more diverting agents can be injected or pumped into a wellbore during injecting a combined solution of aqueous polymer and aqueous cross linker solution into the wellbore. In certain embodiments, the one or more diverting agents can be combined with the solution of aqueous polymer and aqueous cross linker solution before or during injection into a wellbore.

In an embodiment, a first method can include drilling a wellbore into a subterranean environment, creating perforations from the wellbore into the subterranean environment, and harvesting hydrocarbons from the wellbore. In an embodiment, the method can include stimulating hydrocarbon production from the wellbore by fracturing or re-fracturing the wellbore after perforations have been made into the subterranean formation. In an embodiment, a second method can include identifying existing perforations, and sealing the existing perforations by providing a polymer, said polymer including a polyacrylamide polymer having a weight average molecular weight of from about 100 Daltons to about 100,000 Daltons; providing an aqueous crosslinking solution, said aqueous crosslinking solution including a crosslinker having a molecular weight of from about 60 Daltons to about 100,000 Daltons; combining the polymer and the aqueous crosslinking solution before injection into the wellbore or during injection into the wellbore; and forming a crosslinked plug in the wellbore or formation in the subterranean environment, wherein the subterranean environment is located at a distance from the wellbore.

In an embodiment, the methods disclosed herein can include stimulating hydrocarbon production by a third method. In an embodiment, the third method can include isolating section of wellbore, applying pressures to hydraulically fracture the subterranean environment, and harvesting hydrocarbons.

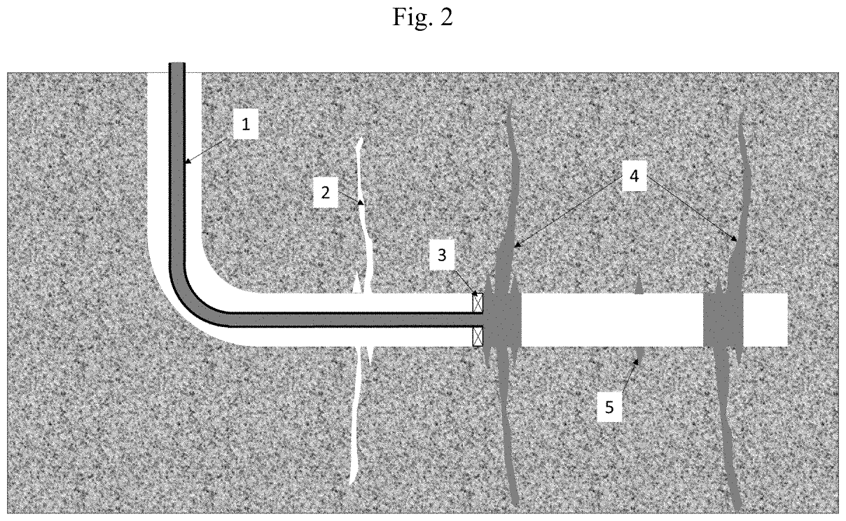

An embodiment of a method of plugging a wellbore or formation in a subterranean environment as disclosed herein is shown in FIG. 2. In such embodiments wellbore intervention equipment can be used, such as coiled tubing, tubing string, or drill pipe with a packer at the end. In the embodiment shown, sealant material is spotted into each opening of the existing perforations and fractures. Once the sealant material is set, the wellbore is cleaned. The existing fractures and perforations can be sealed according to the order of their measured depths, from the deepest depth to shallower depth.

In more detail, referring to FIG. 2, the method can include 1: a wellbore intervention tool such as a tubing string, drill pipe, or coiled tubing; 2: a hydraulic fracture that was created in a previous hydraulic fracturing treatment, which has not been yet sealed by the sealant; 3: a packer at the end of the wellbore intervention tool; 4: fractures that were created in a previous hydraulic fracturing treatment, which have been sealed by the sealant; and 5: perforations that were not fractured in a previous hydraulic fracturing treatment.

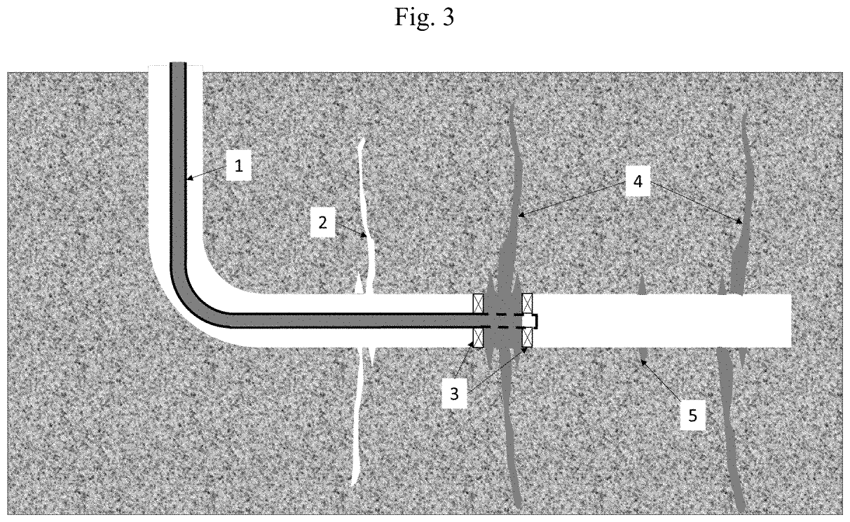

An embodiment of a method of plugging a wellbore or formation in a subterranean environment as disclosed herein is shown in FIG. 3. In such embodiments wellbore intervention equipment can be used, such as coiled tubing, tubing string, or drill pipe with a straddle packer. The straddle packer in the embodiment shown is set to isolate a set of perforation clusters and inject the sealant into the existing perforations and fractures. After all perforations are treated, the wellbore is cleaned. Since a straddle packer is used, there is no specific order to seal the perforations and fractures. Referring to FIG. 3, the method can include 1: a wellbore intervention tool such as tubing string, drill pipe, or coiled tubing; 2: a hydraulic fracture that was created in a previous hydraulic fracturing treatment, which has not been sealed by the sealant yet; 3: a straddle packer at the end of the wellbore intervention tool; 4: fractures that were created in a previous hydraulic fracturing treatment, which have been sealed by the sealant; and 5: perforations that were not fractured in a previous hydraulic fracturing treatment.

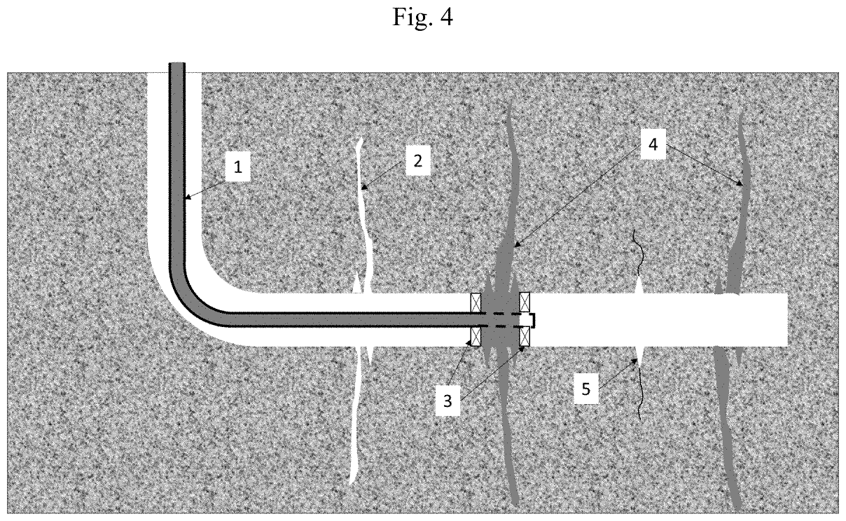

An embodiment of a method of plugging a wellbore or formation in a subterranean environment as disclosed herein is shown in FIG. 4. In such embodiments, wellbore intervention equipment can be used, such as coiled tubing, tubing string, or drill pipe with a straddle packer. In the embodiment shown, a straddle packer is set to isolate a set of perforation clusters. Injection testing can be performed. If fluid can be injected into the perforation cluster isolated, then this set of perforations is sealed with sealant material. If fluid cannot be injected, then this set of perforations is broken down by increasing pressure to allow maximum surface pressure. Such a procedure can be performed for all existing perforation clusters. After all perforations are treated, the wellbore is cleaned and more perforations are added as needed. Proppant and diverting materials can be bullheaded to re-fracture the whole well. Referring to FIG. 4, the method can include 1: a wellbore intervention equipment such as tubing string, drill pipe, or coiled tubing; 2: a hydraulic fracture that was created in a previous hydraulic fracturing treatment, which has not been sealed by the sealant yet; 3: a straddle packer at the end of the wellbore intervention equipment; 4: fractures that were created in a previous hydraulic fracturing treatment, which have sealed by the sealant; and 5: perforations that were not fractured in a previous hydraulic fracturing treatment, that can be broken down for subsequent re-fracturing treatment.

After any of the above embodied methods are performed, a wellbore can then be re-fractured by using any suitable hydraulic fracturing methods, such as bullhead treatment, bullhead with diversion, a plug-and-perf method, fracturing with coil tubing, or sliding sleeve treatment.

Various embodiments herein present methods of plugging a wellbore or formation in a subterranean environment. In an embodiment of the methods, a polymer is provided, which in certain embodiments includes a polyacrylamide polymer in an aqueous polymer solution. Also provided in such embodiments is an aqueous crosslinking solution including a crosslinker, wherein the aqueous polymer solution and aqueous crosslinker solution are combined. The combining of solutions may be performed by adding one solution to another solution, or by mixing the solutions together. The solutions may be combined or mixed from one or more storage containers or tanks, or combined or mixed in a single container or tank. In an embodiment, the aqueous polymer and crosslinker solutions can be combined to form a combined solution before being injected or pumped into the wellbore. In another embodiment, the method can include combining the aqueous polymer and crosslinking solutions during injection or pumping into the wellbore. In various embodied methods, a degradable or non-degradable particulate diversion material can be added to the combined solution the combined solution.

In an embodiment, a crosslinked plug or seal is formed with the combined aqueous polymer and crosslinker solutions in a wellbore in a subterranean environment. In another embodiment, a crosslinked plug or seal is formed with the combined aqueous polymer and crosslinker solutions in a formation in a subterranean environment. In an embodied method, the crosslinked plug or seal isolates or seals an area of the subterranean environment within the wellbore or at a distance from the wellbore. In an embodiment, the subterranean environment is located in a formation at a distance from the wellbore. In an aspect, crosslinked plugs or seals are formed in a subterranean environment at a plurality of distances from a wellbore. In an embodiment, the plug or seal is located at an average distance of from 0 m to about 3 m from the wellbore, of from about 3 m to about 100 m, including from about 5 m to about 50 m, including from about 10 m to about 50 m from the wellbore. In another aspect, the subterranean environment is located in a previously fractured region of a wellbore. In an embodiment, the crosslinked plug or seal can withstand a pressure differential of from about 2000 psi or more, including from about 2000 psi to about 7000 psi, including from about 2000 psi to about 5000 psi, including from about 2500 psi to about 4000 psi.

Another embodiment method provides that at least one of an aqueous polymer solution and/or an aqueous crosslinking solution includes a crosslinking accelerator. A crosslinking accelerator may be included to accelerate the rate of formation of a crosslinked plug in various embodiments. In another embodiment method, a retarding agent is added to at least one of the aqueous polymer solution or the aqueous crosslinking solution. A retarding agent may be added to reduce the rate of formation of a crosslinked plug in various embodiments. Another embodied method includes degrading a plug from a subterranean environment after a duration, by including a crosslinker that is degradable over time in an aqueous crosslinking solution, thereby making the crosslinked plug degradable. In an embodiment, the method includes degrading a plug from a subterranean environment after a duration, by including a breaker that can break down the polymer, thereby making the crosslinked plug degradable.

### Polymers and Crosslinkers of Various Embodiments

An embodiment of the methods includes a polymer which is capable of being crosslinked. The polymer can include a polyacrylamide, polyacrylic acid, polyacrylate salt, polyacrylate ester, polyamine, polyalkyleneimine, or a copolymer of these polymers. In an embodiment, the crosslinkable polymer can be selected from, but not limited to, the following: polymethylacrylate, acrylamide/t-butyl acrylate copolymer, alkyl acrylate polymer, 2-acrylamido-2-methylpropane sulfonic acid/acrylamide copolymers, sulfonated styrene/maleic anhydride copolymers, vinylpyrrolidone/2-acrylamido-2 methylpropane sulfonic acid/acrylamide terpolymers, 2-acrylamido-2-methylpropane sulfonic acid/N-N-dimethy lacrylamide/acrylamide terpolymers, polyethylenimine, dimethylaminoethyl methacrylate, dimethylaminopropyl methacrylamide, or quaternized dimethylaminoethyl methacrylate. In an embodiment, crosslinkable polymers can also include any combination and in any proportion of these compounds.

Some embodied methods provide a polyacrylamide polymer. In an embodiment, the polyacrylamide polymer has a weight average molecular weight of from about 100 Daltons to about 100,000 Daltons. In some embodiments, the polyacrylamide polymer has a weight average molecular weight of from about 100 Daltons to about 50,000 Daltons. In some embodiments, the polyacrylamide polymer has a weight average molecular weight of from about 100 Daltons to about 25,000 Daltons. In some embodiments, the polyacrylamide polymer has a weight average molecular weight of from about 100 Daltons to about 10,000 Daltons. It has been discovered that using polymers, such as polyacrylamide polymer, having a low molecular weight from about 100 Daltons to about 100,000 Daltons provides a crosslinked plug that is strong enough to withstand pressure differentials of from about 2000 psi to about 5000 psi and yet is weak enough so that the residue left in the wellbore is easily drilled out. If the weight average molecular weight of the polyacrylamide polymer goes below 100 Daltons, then the crosslinking reaction may not happen because the polymer chain is not long enough. If the weight average molecular weight of the polyacrylamide polymer goes above 100,000 Daltons, the concentration of the polymer solution is too low to form a plug that is strong enough to withstand pressure differentials of from about 2000 psi to about 5000 psi.

In an embodiment, the polyacrylamide polymer is from about 90 percent to 100 percent linear. In another embodiment, the polyacrylamide polymer is from about 80 percent to 100 percent linear.

An embodiment of the methods includes a crosslinker. In an embodiment, the crosslinker can include a monomer, polymer, or copolymer, or mixtures of amine, imine, vinyl amine or their derivatives. In an embodiment, the crosslinker can include a crosslinking agent containing an amine or imine group capable of crosslinking a polymer containing carbonyl groups. In such an embodiment, the crosslinker can include a diamine, triamine, tetraamine, pentaamine, hexamethylenetetramine, other polyamine, or any combination thereof. In another embodiment, the crosslinker can include a polyalkyleneimine, a polyethyleneimine, a polyalkylenepolyamine, a polyfunctional aliphatic amine, an arylalkylamine, a heteroarylalkylamine, or any combination thereof. The crosslinker can include, but is not limited to, ethylenediamine, tetramethylenediamine, hexamethylenediamine, hexamethylenetetramine, or any combination thereof.

In alternative embodiments, the crosslinker can include a carboxylic acid group capable of crosslinking a polymer containing amine or imine groups. In an embodiment, the crosslinker can include a dicarboxylic acid, tricarboxylic acid, tetracarboxylic acid, pentacarboxylic acid, a polycarboxylic acid, their salts, their derivatives, or any combination thereof. In such embodiments, the crosslinker can include, but is not limited to: oxalic acid, malonic acid, succinic acid, glutaric acid, adipic acid, pimelic acid, suberic acid, azelaic acid, sebacic acid, citric acid, isocitric acid, aconitic acid, propane-1,2,3-tricarboxylic acid, trimesic acid, nitrilotriacetic acid, ethylenediaminetetraacetic acid, their salts, or any mixture of them.

In some embodiments, the crosslinker has a molecular weight of from about 60 Daltons to about 100,000 Daltons. In another embodiment, the crosslinker has a molecular weight of from about 60 Daltons to about 50,000 Daltons. In another embodiment, the crosslinker has a molecular weight of from about 60 Daltons to about 25,000 Daltons. It has been discovered that using cross-linkers, such as diamines, having a molecular weight of from about 60 Daltons to about 50,000 Daltons a crosslinked plug that is strong enough to withstand pressure differentials of from about 2000 psi to about 5000 psi and yet is weak enough so that the residue left in the wellbore is easily drilled out . If the molecular weight of the crosslinker goes above 50,000 Daltons, then the plug is not strong enough to withstand pressure differentials of from about 2000 psi to about 5000 psi.

In an embodiment, the crosslinking agent is degradable over time, thereby making the crosslinked plug degradable. In such an embodiment, the crosslinker can include hexamethylenetetramine. Embodied methods include degrading a plug from a subterranean environment after a duration, by including a degradative amount of hexamethylenetetramine in an aqueous crosslinking solution.

The plug can also be degraded by including an oxidizer breaker, such as bleach, peroxide, or perborate, in an aqueous crosslinking solution.

Without wishing to be bound by theory, it is believed that by controlling the combination of the weight average molecular weight of the polymer, the molecular weight of the crosslinker, and the ratio of the polymer to the crosslinker, that crosslinked plugs are produced that have properties that are superior to those previously used to plug the subterranean formation during hydraulic fracturing or re-fracturing operations. To produce suitable crosslinked plugs in the subterranean formation, it has been found that the ratio of polymer, such as polyacrylamide polymer, and crosslinker when mixed should be controlled to provide a suitable final solution for crosslinking into plugs. Other factors can include concentration of the polymer, such as polyacrylamide polymer, and crosslinker in water or solvent and amounts of retarder or accelerator used in solution. For at least these reasons, various methods of mixing the polymer and crosslinker are discussed in the next section.

### Polymer and Crosslinker Solutions of Various Embodiments

Embodied methods include combining an aqueous polymer solution and an aqueous crosslinking solution to form a combined solution. In an embodiment, the combined solution includes at least one crosslinkable polymer or copolymer and at least one crosslinker. In some embodiments, the polyacrylamide polymer is contained in an aqueous polymer solution at a concentration of from about 30 percent to about 99 percent by weight based on a total weight of the aqueous polymer solution. In other embodiments, the polyacrylamide polymer is contained in an aqueous polymer solution at a concentration of from about 50 percent to about 90 percent by weight based on a total weight of the aqueous polymer solution. In other embodiments, the polyacrylamide polymer is contained in an aqueous polymer solution at a concentration of from about 60 percent to about 80 percent by weight based on a total weight of the aqueous polymer solution. In some embodiments, the crosslinker has a concentration of about 20 percent to about 99 percent weight based on a total weight of the aqueous crosslinker solution. In other embodiments, the crosslinker has a concentration of about 30 percent to about 90 percent weight based on a total weight of the aqueous crosslinker solution. In other embodiments, the crosslinker has a concentration of about 40 percent to about 80 percent weight based on a total weight of the aqueous crosslinker solution. Generally, the concentration of the individual aqueous polymer and/or aqueous crosslinker solution is less important than the ratios and concentrations when combined, because it is the combined solutions that form the plug.

Some embodiments provide that the combined solution has a concentration of about 30 percent to about 80 percent by weight polyacrylamide polymer and from about 10 percent to about 40 percent by weight crosslinker, based on a total weight of the combined solution. In some embodiments, the combined solution has a weight ratio of polyacrylamide to crosslinker of about 5:1 to about 4:1. In some embodiments, the combined solution contains one crosslinker molecule per 5 to 10 monomer units of the polyacrylamide polymer based on an average number of units in the polyacrylamide polymer. In some embodiments, the combined solution has a molar ratio of polyacrylamide to crosslinker of from about 4:1 to about 6:1. Additional embodiments of methods provide combining an aqueous polymer solution and an aqueous crosslinking solution at a ratio of from about 3:1 to about 6:1 by volume to form a combined solution. In some embodiments, such a combined solution is formed before pumping the combined solution into a wellbore. Other embodiments provide for injecting an aqueous polymer solution and an aqueous crosslinking solution at a ratio of from about 3:1 to about 6:1 by volume, simultaneously or in any sequence, and forming a combined solution in a wellbore or in a subterranean environment.

### Accelerators and Retarding Agents of Various Embodiments

Various embodiments provide that at least one of an aqueous polymer solution and an aqueous crosslinking solution includes a crosslinking accelerator. Addition of an accelerator can accelerate the crosslinking reaction in a combined polymer and crosslinker solution. In some embodiments, the crosslinking accelerator can include a base, a Lewis base, or a combination thereof. In such an embodiment, a base including but not limited to NaOH, KOH, ammonia, hydrazine, pyridine, or a combination thereof can be used to accelerate the crosslinking reaction rate.

Other embodiments provide adding a retarding agent to at least one of the aqueous polymer solution and the aqueous crosslinking solution. Addition of a retarding agent can retard or delay the crosslinking process in a combined polymer and crosslinker solution. In some embodiments, the retarding agent can include an acid, a Lewis acid, or a combination thereof. In some embodiments, a protonic acid such as hydrochloric acid, sulfuric acid, phosphoric acid, acetic acid, acetoacetic acid, citric acid can be used to delay the crosslinking time. In other embodiments, a Lewis acid including but not limited to aluminum chloride, zinc chloride, copper chloride, copper sulfate, iron trichloride, or other transition metal salt can also be used to delay the crosslinking reaction at elevated temperatures. The crosslinking functionality can be also be sterically hindered or configured by a retarding agent.

Generally, the amount of accelerator and/or retarder used can be balanced such that the combined solution forms a crosslinked gel at a distance from the wellbore into the formation, and at various wellbore and formation temperatures. If too little retarder or too much accelerator is added then, the crosslinked plug may form at the wrong spot in or too close to the wellbore. If too much retarder or too little accelerator is added, then the crosslinked plug may form too slowly or in too far into the subterranean formation.

### Kits and Devices of Various Embodiments

Generally, the polymer and aqueous crosslinking solution should not be combined more than 24 hours before insertion or pumping the combined solution into a wellbore because it would tend to form a crosslinked plug outside of the wellbore. For at least these reasons, the embodied methods can use a kit or device that separately contains the polymer and aqueous crosslinking solution until they are ready to be used.

Embodiments herein include a kit or device for plugging a wellbore. Some embodiments of such a kit or device can provide a polymer vessel and a crosslinker vessel. In an embodiment, the polymer vessel can contain an aqueous polymer solution. In an embodiment, the aqueous polymer solution can include a polyacrylamide polymer. In such an embodiment, the polyacrylamide polymer can have a weight average molecular weight of from about 100 Daltons to about 100,000 Daltons, including from about 200 Daltons to about 100,000 Daltons. In some embodiments, the polyacrylamide polymer has a concentration of from about 30 percent to about 99 percent by weight based on a total weight of the aqueous polymer solution. In some embodiments, the polyacrylamide polymer is from about 90 percent to 100 percent linear. An embodiment provides a crosslinker vessel containing an aqueous crosslinking solution including a crosslinker. In some embodiments, the crosslinker is at a concentration of about 20 percent to about 99 percent by weight based on a total weight of the aqueous crosslinker solution. An embodiment herein provides that the polymer vessel and the crosslinker vessel of the kit or device are separated. In such an embodiment, the polymer vessel and the crosslinker vessel can be transported downhole into a wellbore, allowing the aqueous polymer solution and the aqueous crosslinker solution to be kept separate until they are combined or mixed together at a desired downhole location.

In an embodiment, the polymer vessel and crosslinker vessel can each include a bottle, a can, and a 55 gallon drum, one vehicles having two or more compartments, or two or more vehicles each containing at least one of the polymer or the crosslinking solution.

### EXAMPLES

### Example 1

Polyacrylamide with a weight average molecular weight of about 10,000 Daltons, was purchased from Polysciences Inc. Crosslinkers, including Ethylenediamine, Hexamethylenediamine, Hexamethylenetetramine, and Polyethylenimine (molecular weight less than 100,000), were purchased from Sigma-Aldrich. Polyacrylamide and various crosslinkers were mixed in glass beakers according to the ratios below and stirred well with a glass bar. After the components were fully mixed, the glass vials were tightly capped and heated to 95° C. in an oven over night. The samples were inspected the next day. In all experiments listed below, the initial liquid samples transformed into a strong crosslinked gel.

| Experiment # | Composition 1 | Composition 2 |
|---|---|---|
| 1 | Polyacrylamide, | Ethylenediamine, |
| | 50% (w/w) solution, 3 ml | liquid, 1 ml |
| 2 | Polyacrylamide, | Hexamethylenediamine, |
| | 50% (w/w) solution, 3 ml | 70% water solution, 2.5 ml |
| 3 | Polyacrylamide, | Hexamethylenetetramine, |
| | 50% (w/w) solution, 5 grams | 1 gram |
| 4 | Polyacrylamide, | Polyethylenimine (PEI), |
| | 50% (w/w) solution, 3 ml | 50% (w/w) solution, 1.2 ml |

### Example 1A

Example 1A can be performed as in Example 1, except that a polyacrylamide with a weight average molecular weight of less than 100,000 Daltons would be used.

### Example 2

Polyacrylic acid with an average molecular weight of about 10,000 Da was purchased from Sigma-Aldrich. The powder was weighed and mixed with water to prepare a 40% (w/w) aqueous solution. Polyethylenimine (molecular weight less than 100,000) was purchased from Sigma-Aldrich. Polyacrylic acid and polyethylenimine were mixed in glass vials according to the composition below and stirred well with a glass bar. After the components were fully mixed, the vials were tightly capped and stored at 110° C. in an oven over night. The samples were inspected the next day. All initial liquid samples transformed into strong crosslinked gels.

| Experiment # | Composition 1 | Composition 2 |
|---|---|---|
| 5 | Polyacrylic acid, | Polyethylenimine (PEI), |
| | 40% (w/w), 4 ml | 50% (w/w), 2 ml |

### Example 2A

Example 1A can be performed as in Example 2, except that a polyacrylamide with a weight average molecular weight of less than about 400,000 Daltons would be used.

### Example 3

Polymethylacrylate (molecular weight less than 400,000), ethylenediamine, and hexamethylenediamine were purchased from Sigma-Aldrich. Polymethylacrylate was mixed with either ethylenediamine or hexamethylenediamine in glass vials according to the compositions below and stirred well with a glass bar. After the components were fully mixed, the glass vials were tightly capped and stored at 105° C. in an oven over night. The samples were inspected the next day. All initial liquid samples transformed into crosslinked gels.

| Experiment # | Composition 1 | Composition 2 |
|---|---|---|
| 6 | polymethylacrylate, | Ethylenediamine, |
| | 40% solution in toluene, 4 ml | liquid, 0.5 ml |
| 7 | polymethylacrylate, | Hexamethylenediamine, |
| | 40% solution in toluene, 4 ml | 1.75 gram |

### Example 4

Polyethylenimine (molecular weight less than 100,000), succinic acid, and citric acid were purchased from Sigma-Aldrich. Polyethylenimine and succinic acid or citric acid were mixed with each other in glass vials according to the compositions below and stirred well with a glass bar. After the components were fully mixed, the glass vials were tightly capped and stored at 115° C. in an oven over night. The samples were inspected next day. All initial liquid samples transformed into crosslinked gels.

| Experiment # | Composition 1 | Composition 2 |
|---|---|---|
| 8 | Polyethylenimine (PEI), | Succinic acid, |
| | 50% (w/w) solution, 4 ml | 2.5 gram |
| 9 | Polyethylenimine (PEI), | Citric acid, |
| | 50% (w/w) solution, 4 ml | 3.9 gram |

### Example 5

Polyacrylamide with a weight average molecular weight of about 10,000 was purchased from Polysciences Inc. Hexamethylenediamine was purchased from Sigma-Aldrich. Hexamethylenediamine was dissolved in water to prepare 70% (w/w) solution. Polyacrylamide and hexamethylenediamine water solutions were mixed in glass beakers according to the compositions below. The samples were stirred well with a glass bar.

| Experiment # | Composition 1 | Composition 2 |
|---|---|---|
| 10 | Polyacrylamide, | Hexamethylenediamine, |
| | 50% (w/w) solution, 30 ml | 70% (w/w) solution, 25 ml |
| 11 | Polyacrylamide, | Hexamethylenediamine, |
| | 50% (w/w) solution, 30 ml | 70% (w/w) solution, 4.8 ml |

A fit for purpose laboratory apparatus has been designed and built to measure how much differential pressure the crosslinked material can hold after it is placed in-situ. In the fit for purpose test apparatus, there is a tubular reactor that is 1 foot long and has 0.532 inch inner diameter. Firstly, 16.5 gram of 20/40 proppant was transferred into the tubular reactor, then a liquid mixture as mentioned above was filled into the tubular reactor. The tubular reactor was connected to the apparatus. The tubular reactor was heated to 250° F. for overnight. Then the pressure to the inlet of the tubular reactor was increased to 5000 psi, while the pressure at the outlet of the tubular reactor was monitored. Temperature, as well as the inlet and outlet pressures were recorded accordingly. The pressure of the inlet was held at 5000 psi for about 3 hours, then the pressure was released. After a waiting time (usually 1 to 12 hours), the inlet pressure was increased again and the experiment was repeated. This experiment with pressure cycles was repeated for 30 days. During this period, the temperature was maintained at 250° F.

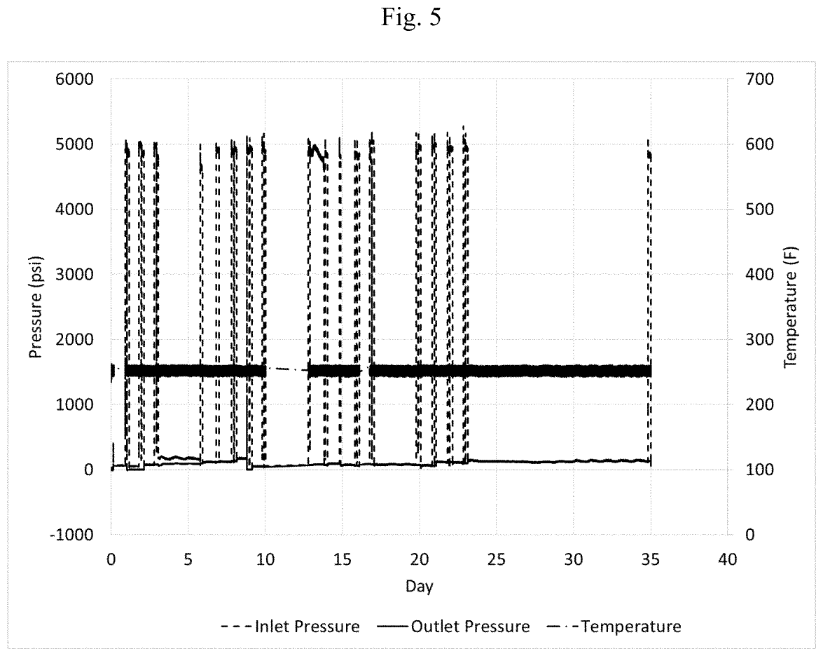

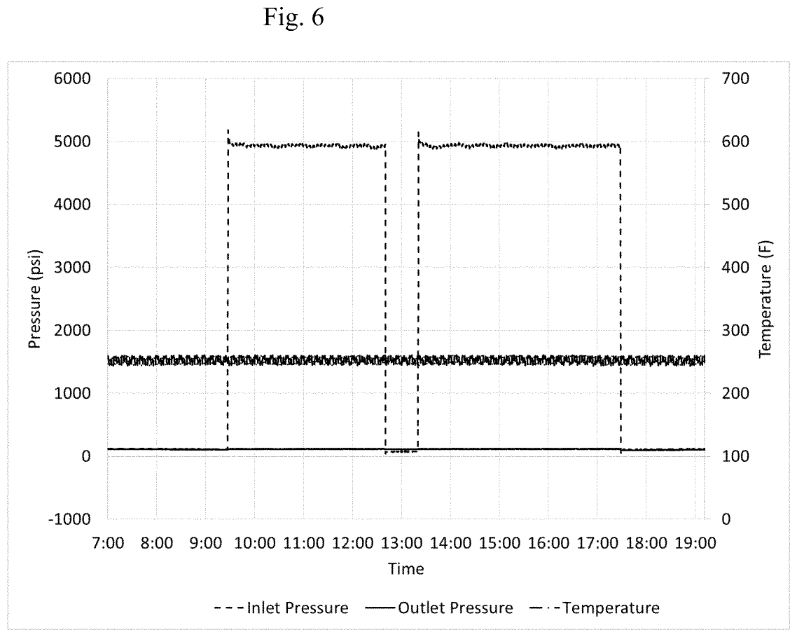

Experimental results of Experiment 10 are shown in FIG. 5 and FIG. 6. The results indicate that these novel compositions have the ability to hold a 5,000 psi differential pressure at a temperature of 250° F. for over 30 days. Moreover, in the cyclic test, the material underwent 30 days without breaking down nor incurring a pressure loss. This result indicates that these formulations are stable and strong enough to create an effective seal for a wellbore or in a formation (see FIG. 5 and FIG. 6).

### Example 5A

Examples 1 and 2 can be performed as in Experiment 10 and 11, except that a different type of crosslinker can be used.

### Example 6

A sealant material (polyacrylamide with a weight average molecular weight of about 10,000, hexamethylenediamine, 70% (w/w) solution, and sodium hydroxide) was pumped down as liquid into a well that had been previously hydraulically fractured. After a period of 7 days to let the sealant material harden, the material left in the wellbore was drilled out, and a pressure test was performed.

1. Plastic particles (diameter 2 to 4 mm) were first pumped into the wellbore. These particles functioned as a diverter material. The particles will partially block the perforations that tend to take most of the fluid, so that later on when pumping the sealant material, the sealant material can seal all perforations, rather than just a few of the perforations.

2. The sealant material was pumped into the wellbore. During the pumping, a break down—squeeze sequence was used. There may be some perforation holes that were shot but not fractured during the initial frac treatment. When pumping the sealant material, the injection pressure is controlled to above formation breakdown pressure. This can break down the formation behind such perforation holes, which are then filled by the sealant material. This helps to seal all the perforation holes, no matter whether the hole was fractured or not fractured in the initial fracture treatment.

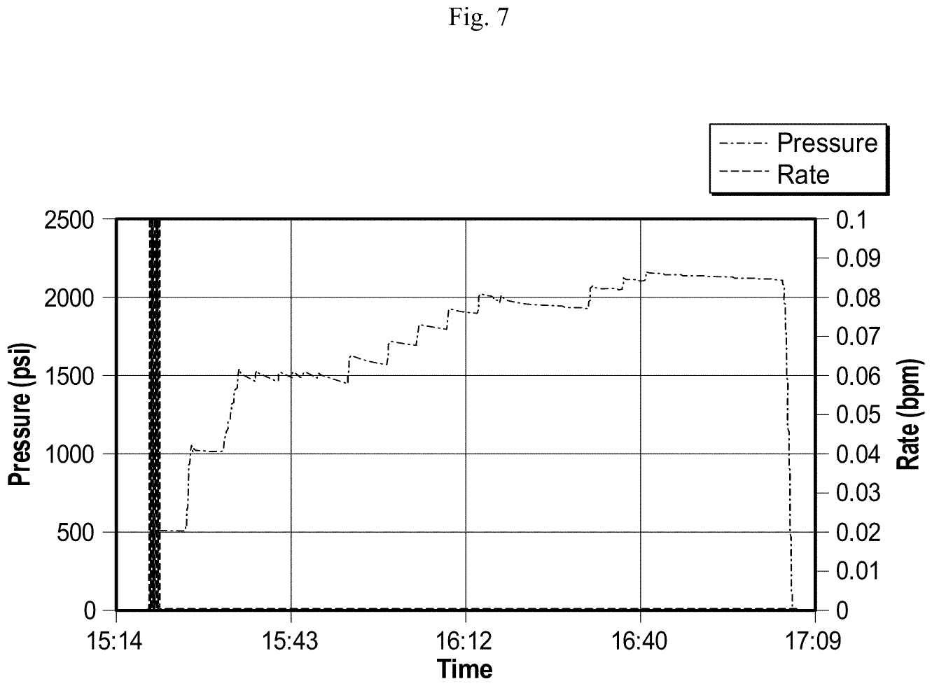

3. After waiting for 7 days, the wellbore was drilled out, and a pressure test was performed. Results of the pressure test are shown in FIG. 7. The results show that the sealant material can hold a pressure of 2150 psi applied to the wellhead, which corresponds to 5065 psi differential pressure at bottom hole with a reservoir pressure at 393 psi, according to the following equation:

2150+0.05192×8.34×(7630+7644)/2−393=5065

Note: 7630 and 7644 ft are the top and bottom depth of the perforations.

### Example 7

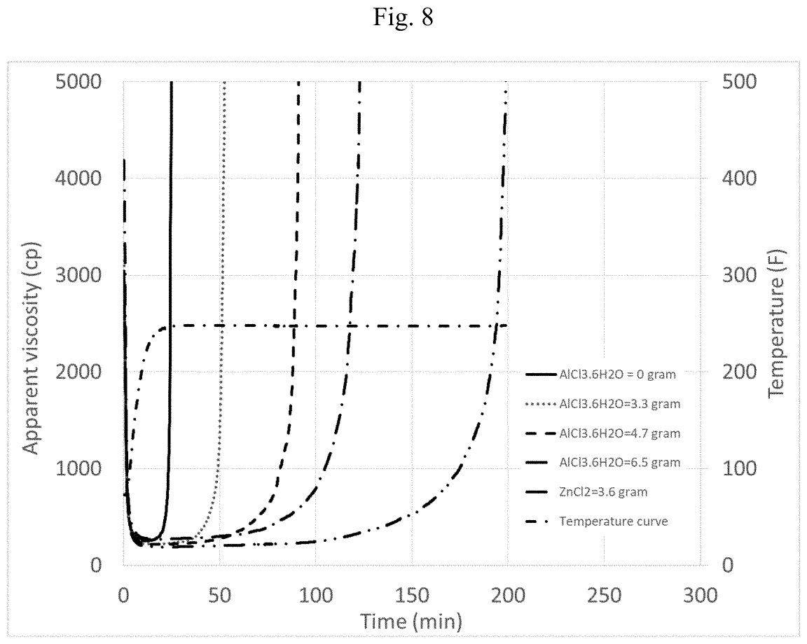

In this set of experiments, the crosslinking rate was modified using AlCl₃.6H₂O or ZnCl₂. The polyacrylamide with a weight average molecular weight of about 10,000 was purchased from Polysciences Inc. Hexamethylenediamine was purchased from Sigma-Aldrich. A 70% (w/w) aqueous solution of Hexamethylenediamine was prepared. AlCl₃.6H₂O was purchased from Consolidated Chemical. The three compositions were mixed together. The mixture was transferred into the sample cup of the Chandler 5550 rheometer. The cup was pressured to 100 psi with nitrogen gas, then the cup was heated to 250° F. The apparent viscosity was measured at 15 s⁻¹. Measurements were stopped once an abrupt viscosity increase was observed. The results show that transition metal salts which function as Lewis acids, such as AlCl₃ and ZnCl₂ can be used to modify the crosslinking reaction rate. (FIG. 8)

| | Polyacrylamide, | Hexamethylenediamine, | AlCl₃•6H₂O, | ZnCl₂ |
|---|---|---|---|---|
| Experiment # | 50% (w/w) solution, gram | 70% (w/w) solution, gram | gram | gram |
| 12 | 90 | 14.8 | 0 | |
| 13 | 90 | 14.8 | 3.3 | |
| 14 | 90 | 14.8 | 4.7 | |
| 15 | 90 | 14.8 | 6.5 | |
| 16 | 90 | 14.8 | | 3.6 |

### Example 8

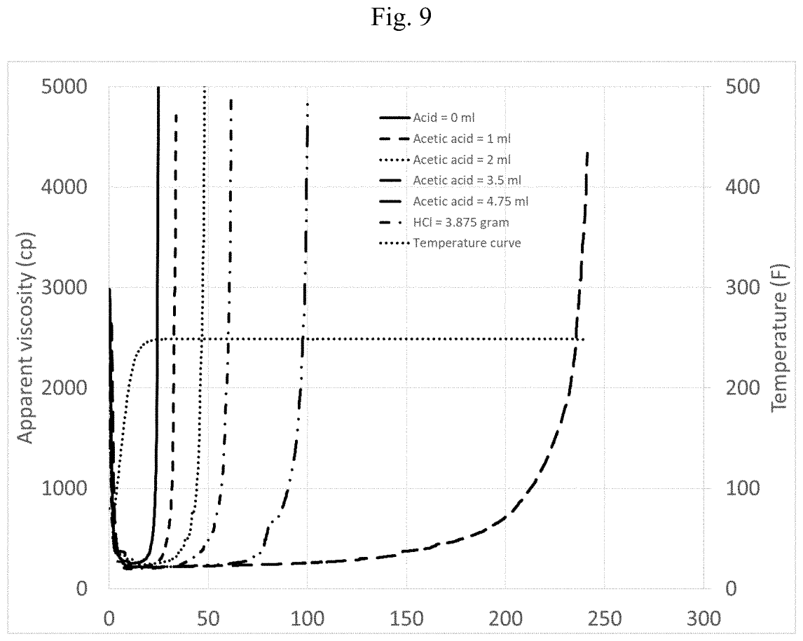

In this set of experiments, the crosslinking reaction rate was modified using acetic acid and hydrochloric acid. The polyacrylamide (molecular weight less than about 100,000) was purchased from Polysciences Inc. It was prepared as a 50% (w/w) aqueous solution. Hexamethylenediamine, glacial acetic acid, and hydrochloric acid (37% w/w in water) were purchased from Sigma-Aldrich. Hexamethylenediamine was mixed with water to prepare a 70% (w/w) aqueous solution. The chemicals were mixed together as listed in the table below. The mixture was loaded into the sample cup of the Chandler model 5550 rheometer. After the cup was pressured to 100 psi with nitrogen gas, the cup was heated to 250° F. The apparent viscosity was then measured at 15 s⁻¹. Measurements were stopped once an abrupt viscosity increase was observed. The results show that protonic acids such as acetic acid and hydrochloric acid can be used to modify the crosslinking reaction rate. (FIG. 9)

| | Polyacrylamide, | Hexamethylenediamine, | Acetic | HCl, |
|---|---|---|---|---|
| Experiment # | 50% (w/w) solution, gram | 70% (w/w) solution, gram | acid, ml | 37% (w/w), gram |
| 17 | 90 | 14.8 | 0 | 0 |
| 18 | 90 | 14.8 | 1 | 0 |
| 19 | 90 | 14.8 | 2 | 0 |
| 20 | 90 | 14.8 | 3.5 | 0 |
| 21 | 90 | 14.8 | 4.75 | 0 |
| 22 | 90 | 14.8 | 0 | 3.875 |

### Example 9

Polyacrylamide with a weight average molecular weight of about 10,000 was purchased from Polysciences Inc. Hexamethylenetetramine was purchased from Sigma-Aldrich. Polyacrylamide and hexamethylenetetramine were mixed well using a glass rod in a beaker, according to the composition ratio listed below.

| Experiment # | Composition 1 | Composition 2 |
|---|---|---|
| 23 | Polyacrylamide, | Hexamethylenetetramine, |
| | 50% (w/w) solution, 50 gram | 7 gram |

A fit for purpose laboratory apparatus has been designed and built to investigate the potential degradation of sealant materials at elevated temperatures over time. In the fit for purpose test apparatus, there is a tubular reactor that is 1 foot long and has an inner diameter of 0.532 inch. During the experiment, 16.5 gram of 20/40 proppant was transferred into the tubular reactor, then a liquid composition mixture as mentioned above was filled into the tubular reactor. The tubular reactor was connected to the apparatus. The tubular reactor was heated to 300° F. for overnight. Then pressure was applied to the inlet of the tubing to test how much differential pressure the material can sustain over a certain period of time. If the sealant material started to degrade over time, it could no longer hold a differential pressure and a change of pressure could be observed at the outlet end. Temperature, as well as the inlet and outlet pressures, were recorded accordingly. This experiment was on-going for 7 days until the material could no longer hold a differential pressure. During this period, the temperature was maintained at 300° F.

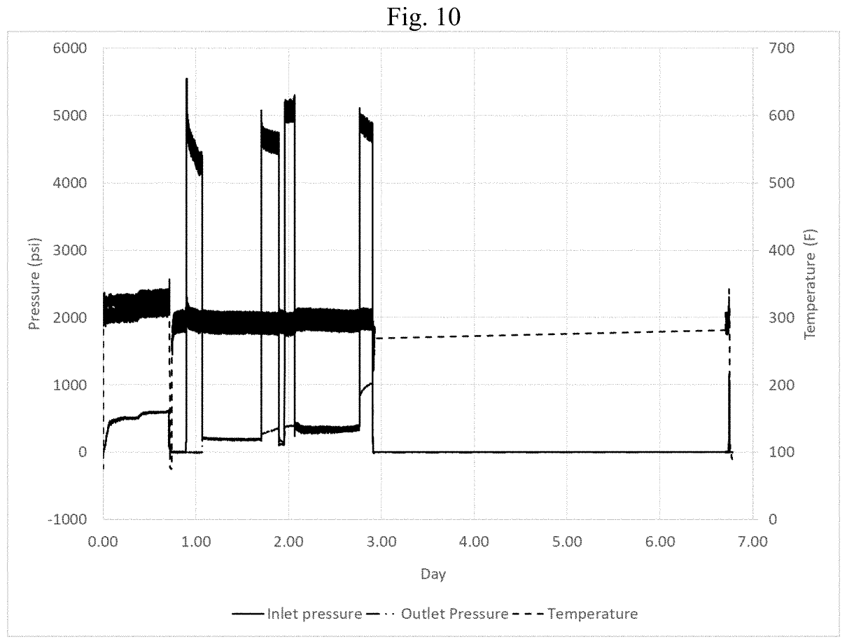

Experimental results indicate that these compositions have the ability to hold a 5,000 psi differential pressure at a temperature of 300° F. after 1.7 days. The material mostly degraded and held no differential pressure after 6.7 days. (see FIGS. 10-12). The results of this experiment indicate that the sealant material is degradable over time at an elevated temperature.

### Example 10

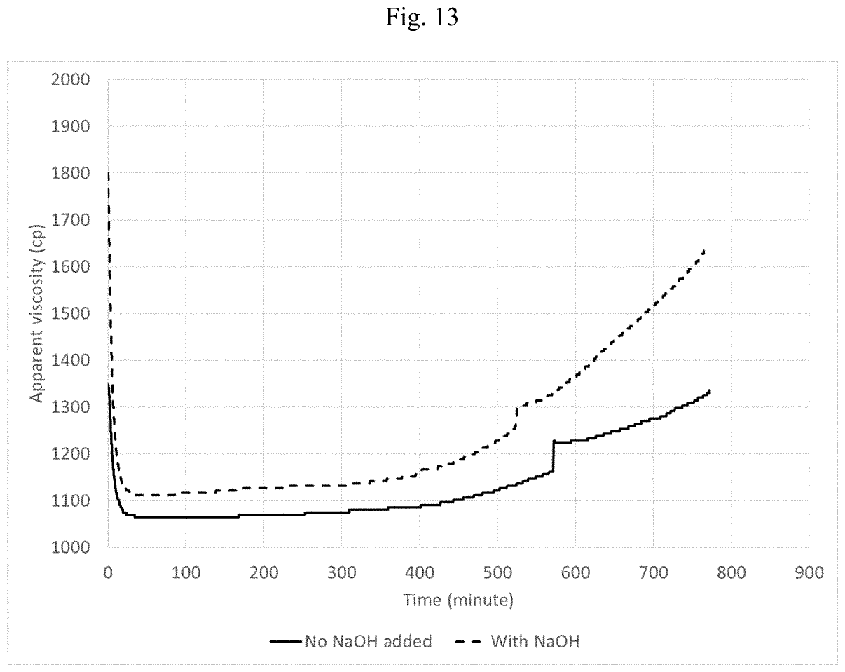

In this set of experiments, the crosslinking rate was modified using NaOH. The polyacrylamide with a weight average molecular weight of about 10,000) was purchased from Polysciences Inc. Hexamethylenediamine and NaOH were purchased from Sigma-Aldrich. A 70% (w/w) aqueous solution of Hexamethylenediamine was prepared. The compositions were mixed together. The mixture was transferred into the sample cup of the Chandler 5550 rheometer. The cup was heated to 90° F. The apparent viscosity was measured at 15 s−1. The results show that a base can be used to modify the crosslinking reaction rate (FIG. 13).

| | Polyacrylamide, | Hexamethylenediamine, | |
|---|---|---|---|
| Experiment # | 50% (w/w) solution, gram | 70% (w/w) solution, gram | NaOH, gram |
| 24 | 70 | 22.4 | 0 |
| 25 | 70 | 22.4 | 1.8 |

### Discussion of Results

An embodiment of a method of plugging a wellbore or formation in a subterranean environment as disclosed herein is shown in FIG. 5. Sealant material was filled with a one-foot-long, 0.532 in ID stainless steel tubing. This tubing was heated to 250° F. for 20 hours. Then 5000 psi was put at the inlet of the tubing, held for 2 to 20 hours, then released after 2 to 20 hours. The experiment lasted 35 days. During these days, the pressure-up, pressure-down process was repeated multiple times to simulate the cyclical differential pressure the sealant material would undergo during a re-fracturing process. The temperature was maintained throughout the experiment at 250° F. The pressure at inlet (dashed line) and outlet of the tubing (solid line), and temperature (dash-dotted line) were recorded throughout the experiment. The outlet pressure was close to 0 psi all the time, proving that the sealant in the tubing can hold 5000 psi differential pressure at 250° F. while undergoing cyclic pressure loading for 35 days. Thus the material can act as a sealant material under downhole conditions.

An embodiment of a method of plugging a wellbore or formation in a subterranean environment as disclosed herein is shown in FIG. 6. FIG. 6 shows a graph of a subset of the results shown in FIG. 5, to reveal more details of the experiment results.

An embodiment of a method of plugging a wellbore or formation in a subterranean environment as disclosed herein is shown in FIG. 7. Sealant material was injected into a wellbore that had been previously hydraulically fractured and allowed to set for 7 days. A break down-squeeze sequence was used during the injection. Sealant material remaining in the wellbore was drilled out, then a pressure test was conducted. FIG. 7 shows that the sealant material can hold at 2150 psi wellhead pressure, which corresponds to 5065 psi differential pressure at the bottom of the hole with a reservoir pressure at 393 psi.

An embodiment of a method of plugging a wellbore or formation in a subterranean environment as disclosed herein is shown in FIG. 8. FIG. 8 shows that AlCl₃ and ZnCl₂ can be used as retarders to adjust the starting time of the crosslinking reaction. In this set of experiments, the concentration of the polymer and crosslinker remained the same for all tests. Various concentrations of AlCl₃ were evaluated. All tests were performed at 250° F. As the concentration of AlCl₃ increased, the time of initiation of the crosslinking reaction was further delayed.

An embodiment of a method of plugging a wellbore or formation in a subterranean environment as disclosed herein is shown in FIG. 9. FIG. 9 shows that hydrochloric acid and acetic acid can be used as retarders to adjust the starting time of the crosslinking reaction. In this set of experiments, the concentration of the polymer and crosslinker remained the same for all tests. Various concentrations of acetic acid were evaluated. All tests were performed at 250° F. As the concentration of acetic acid increased, the time of initiation of the crosslinking reaction was further delayed.

An embodiment of a method of plugging a wellbore or formation in a subterranean environment as disclosed herein is shown in FIG. 10. FIG. 10 shows the results of a sealant material degradation experiment. In this experiment, a one-foot-long, 0.532 in ID stainless steel tubing was filled with a sealant material. The tubing was heated to 300° F. throughout the experiment. Then pressure was applied to the inlet of the tubing to test how much differential pressure the material can sustain over a certain period of time. This experiment demonstrates that the sealant material is degradable over time.

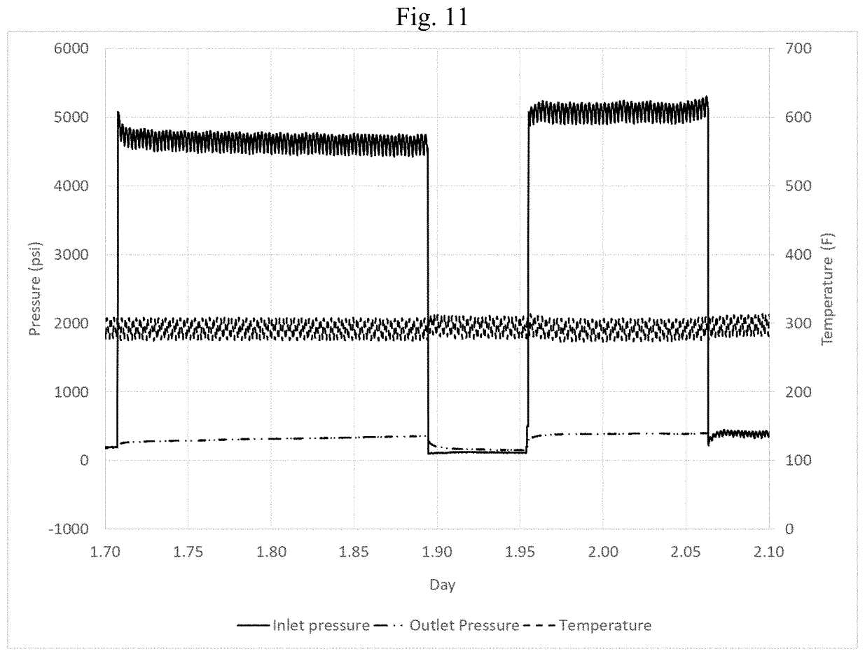

An embodiment of a method of plugging a wellbore or formation in a subterranean environment as disclosed herein is shown in FIG. 11. FIG. 11 shows a zoom-in subsection of the results in FIG. 10. These results show that after the material was heated at 300° F. for 1.7 days, the sealant material held 5000 psi at inlet pressure, while no significant leakage was observed at the outlet of the tubing.

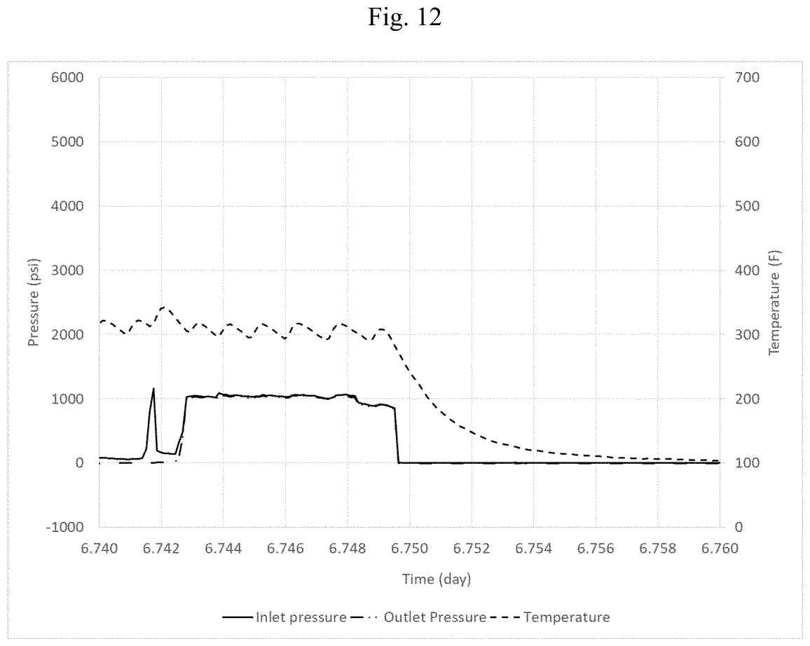

An embodiment of a method of plugging a wellbore or formation in a subterranean environment as disclosed herein is shown in FIG. 12. FIG. 12 shows a zoom-in subsection of the results in FIG. 10. These results show that after the material was heated at 300° F. for 6.7 days, when 1000 psi pressure being applied to the inlet end, the pressure observed at the outlet also immediately increased to 1000 psi. These results indicate that the sealant material mostly degraded after 6.7 days at 300° F.

An embodiment of a method of plugging a wellbore or formation in a subterranean environment as disclosed herein is shown in FIG. 13. FIG. 13 shows that NaOH can be used as an accelerator to adjust the crosslinking rate. In this set of experiments, the concentration of the polymer and crosslinker remained the same for both tests. Both tests were performed at 90° F. The solid line shows that viscosity increased without NaOH, while the dotted line shows that viscosity increased faster with NaOH. These results indicate that the crosslinking rate is faster with NaOH added.

What is claimed is:

1. A method of plugging a wellbore or formation in a subterranean environment comprising:
providing a polymer, said polymer including a polyacrylamide polymer having a weight average molecular weight of from about 100 Daltons to about 100,000 Daltons;
providing an aqueous crosslinking solution, said aqueous crosslinking solution including a crosslinker having a molecular weight of from about 60 Daltons to about 100,000 Daltons;
combining the polymer and the aqueous crosslinking solution before injection into the wellbore or during injection into the wellbore; and
forming a crosslinked plug in the wellbore or formation in the subterranean environment, wherein the subterranean environment is located at a distance from the wellbore.

2. The method of claim 1, wherein the polyacrylamide polymer is from about 90 percent to 100 percent linear; or
wherein the polymer is contained in an aqueous polymer solution, and the polyacrylamide polymer has a concentration of from about 40 percent to about 99 percent by weight based on a total weight of the aqueous polymer solution.

3. The method of claim 1, wherein the crosslinker has a concentration of about 20 percent to about 99 percent weight based on a total weight of the aqueous crosslinker solution.

4. The method of claim 3, further comprising:
combining the aqueous polymer solution and the aqueous crosslinking solution to form a combined solution, wherein the combined solution has a concentration of about 30 percent to about 80 percent by weight polyacrylamide polymer and from about 10 percent to about 40 percent by weight crosslinker based on a total weight of the combined solution.

5. The method of claim 4, wherein the combined solution has a weight ratio of the polyacrylamide polymer to the crosslinker of about 5:1 to about 4:1.

6. The method of claim 5, wherein the combined solution contains one crosslinker molecule per 5 to 10 monomer units of the polyacrylamide polymer based on an average number of units in the polyacrylamide polymer; or
wherein the combined solution has a molar ratio of polyacrylamide polymer to crosslinker of from about 4:1 to about 6:1.

7. The method of claim 6, wherein the crosslinked plug can withstand a pressure differential of from about 2000 psi to about 5000 psi.

8. The method of claim 1, wherein the crosslinker is selected from diamine, triamine, tetraamine, pentaamine, hexamethylenetetramine, and combinations thereof.

9. The method of claim 1, further comprising:
provided that the crosslinker includes hexamethylenetetramine,
degrading the plug from the subterranean environment after a duration by including a degradative amount of hexamethylenetetramine in the aqueous crosslinking solution.

10. The method of claim 3, further comprising:
combining the aqueous polymer solution and the aqueous crosslinking solution at a ratio of from about 3:1 to about 6:1 by volume to form a combined solution before pumping the combined solution into the wellbore or
further comprising:
injecting the aqueous polymer solution and the aqueous crosslinking solution at a ratio of from about 3:1 to about 6:1 by volume, simultaneously or in any sequence, and
forming a combined solution in the wellbore or the subterranean environment.

11. The method of claim 3, wherein at least one of the aqueous polymer solution and the aqueous crosslinking solution includes a crosslinking accelerator, and the crosslinking accelerator includes a base or a Lewis base or a combination thereof.

12. The method of claim 3, wherein at least one of the aqueous polymer solution and the aqueous crosslinking solution includes a crosslinking accelerator, and the crosslinking accelerator includes NaOH, KOH, ammonia, hydrazine, pyridine, or a combination thereof.

13. The method of claim 3, further comprising: adding a retarding agent, wherein the retarding agent includes an acid or a Lewis acid, to at least one of the aqueous polymer solution and the aqueous crosslinking solution.

14. The method of claim 3, further comprising: adding a retarding agent to at least one of the aqueous polymer solution and the aqueous crosslinking solution, wherein the retarding agent includes hydrochloric acid, sulfuric acid, phosphoric acid, acetic acid, acetoacetic acid, citric acid, aluminum chloride, zinc chloride, copper chloride, copper sulfate, iron trichloride, or other transition metal salt.

15. The method of claim 1, wherein the polyacrylamide polymer has a weight average molecular weight of from about 100 Daltons to about 50,000 Daltons.

16. The method of claim 1, further comprising:
providing one or more diverter materials; and
injecting the one or more diverter materials into the wellbore before, during, or after injection of the polymer solution and the aqueous crosslinking solution into the wellbore.

17. A method of plugging a wellbore comprising:
isolating an area of a subterranean environment within a wellbore or at a distance from the wellbore;
providing an aqueous polymer solution, said aqueous polymer solution including a polyacrylamide polymer having weight average molecular weight of from about 100 Daltons to about 100,000 Daltons and a concentration of from about 40 percent to about 99 percent by weight based on a total weight of the aqueous polymer solution, wherein said polyacrylamide polymer is from about 90 percent to 100 percent linear;
providing an aqueous crosslinking solution, said aqueous crosslinking solution including a crosslinker at a concentration of from about 20 percent to about 99 percent by weight based on a total weight of the aqueous crosslinker solution;
pumping the aqueous polymer solution and the aqueous crosslinker solution into the wellbore, or forming a combined solution by mixing the aqueous polymer solution and the aqueous crosslinker solution and pumping the combined solution into the wellbore; and
forming a crosslinked plug in the subterranean environment within the wellbore or at said distance from the wellbore.

18. The method of claim 17, wherein the subterranean environment is located in a previously fractured region of the wellbore.

19. The method of claim 17, further comprising: forming crosslinked plugs in the subterranean environment at a plurality of distances from the wellbore.

20. A kit or device for plugging a wellbore comprising:
a polymer vessel and a crosslinker vessel,
wherein the polymer vessel contains an aqueous polymer solution, said aqueous polymer solution including a polyacrylamide polymer having a weight average molecular weight of from about 100 Daltons to about 100,000 Daltons and a concentration of from about 40 percent to about 99 percent by weight based on a total weight of the aqueous polymer solution, wherein said polyacrylamide polymer is from about 90 percent to 100 percent linear;
wherein the crosslinker vessel contains an aqueous crosslinking solution, said aqueous crosslinking solution including a crosslinker at a concentration of about 20 percent to about 99 percent by weight based on a total weight of the aqueous crosslinker solution, and
wherein the polymer vessel and the crosslinker vessel of the kit or device are separated.
